(19) United States
(12) Patent Application Publication
(10) Pub. No.: US 2013/0026810 A1
(43) Pub. Date: Jan. 31, 2013

(54) Cutting Tool Assembly with Protective Member

(71) Applicants: Randall Walter Ojanen, Sullivan, TN (US); Don C. Rowlett, Bedford, PA (US)

(72) Inventors: Randall Walter Ojanen, Sullivan, TN (US); Don C. Rowlett, Bedford, PA (US)

(73) Assignee: KENNAMETAL INC., Latrobe, PA (US)

(21) Appl. No.: 13/189,948

(22) Filed: Jul. 25, 2011

(51) Int. Cl. E21C 35/19; F16B 43/02; E21C 35/18

(52) U.S. Cl. 299/104; 411/546

(57) ABSTRACT

A cutting tool assembly for use in impinging earth strata includes a holder containing a bore having an axial forward end, and the holder having a forward surface surrounding the bore at the axial forward end of the bore. The assembly also includes a cutting tool being rotatably contained within the bore of the holder, and the cutting tool having a rearwardly facing shoulder. The assembly further includes a protective member positionable between the cutting tool and the holder. The protective member has a first surface adjacent the rearwardly facing shoulder of the cutting tool and a second surface adjacent to the forward surface of the holder, wherein the first surface has a first hardness that is greater than a second hardness of the second surface. In one aspect, the second surface of the protective member is in direct contact with the forward surface of the holder. In another aspect, the first surface of the protective member is in direct contact with the rearwardly facing shoulder of the cutting tool.

### BACKGROUND OF THE INVENTION

The invention pertains generally to a cutting tool assembly that is useful for the impingement of a substrate or earth strata such as, for example, asphaltic roadway material, coal deposits, mineral formations and the like. Such cutting tool assemblies typically include a rotatable cutting tool positioned in a tool holder including, but not limited to, a base or block that is affixed to a rotatable drum or a quick change tool holder and/or sleeve as is generally known.

As can be appreciated, these rotatable cutting tools and the holders operate in a severe environment that causes wear on these components, as well as other possible failures due to the severity of the operating conditions. While it is inevitable that the cutting tools experience wear, the ability of the cutting tool to rotate about its central longitudinal axis during operation generally prolongs the useful life of the cutting tool. It can thus be appreciated that features of the cutting tool or cutting tool assembly that facilitate the rotation of the cutting tool during operation are beneficial to the operation of the cutting tool (and cutting tool assembly) and the overall operation of the earth strata cutting machine.

As known to those skilled in the art, the useful life of the holder is much longer than the useful life of the cutting tool. Each holder is intended to accommodate many changes of cutting tools held thereby until it is necessary to replace the holder. In the case of an earth strata cutting machine like a road milling machine, it is important to maintain the milling pattern. One factor that influences the milling pattern is the degree of wear that is suffered by the forward face of the holder. In order to reduce the wear on the forward face of the holder a protective member, e.g. a washer has been carried by the cutting tool that is mediate of the cutting tool and holder. The protective member protects the forward face of the holder from wear.

However, it would still be desirable to provide an improved cutting tool assembly that improves upon known cutting tool assemblies. It would also be desirable to provide an improved cutting tool assembly that better protects the forward face of the holder from wear.

### SUMMARY OF THE INVENTION

In accordance with an aspect of the invention, a cutting tool assembly for use in impinging earth strata includes a holder containing a bore, a cutting tool rotatably contained within the bore of the holder and a protective member mediate of the cutting tool and the holder. The protective member has a first surface adjacent to the cutting tool and a second surface adjacent the holder, wherein the first surface has a first hardness that is different than a second hardness of the second surface. In one aspect, the first hardness is greater than the second hardness.

In another aspect of the invention, a cutting tool assembly for use in impinging earth strata includes a holder containing a bore having an axial forward end, and the holder having a forward surface surrounding the bore at the axial forward end of the bore. The assembly also includes a cutting tool being rotatably contained within the bore of the holder, and the cutting tool having a rearwardly facing shoulder. The assembly further includes a protective member positionable between the cutting tool and the holder. The protective member has a first surface adjacent the rearwardly facing shoulder of the cutting tool and a second surface adjacent the forward surface of the holder, wherein the first surface has a first hardness that is greater than a second hardness of the second surface. In one aspect, the second surface of the protective member is in direct contact with the forward surface of the holder. In another aspect, the first surface of the protective member is in direct contact with the rearwardly facing shoulder of the cutting tool.

In accordance with yet another aspect of the invention, a protective member positioned between a holder containing a bore and a cutting tool being rotatably contained within the bore of the holder to provide a cutting tool assembly for use in impinging earth strata includes a first surface adjacent to the cutting tool and a second surface adjacent to the holder, wherein the first surface has a first hardness that is greater than a second hardness of the second surface.

In another aspect of the invention, a cutting tool assembly for use in impinging earth strata includes a holder containing a bore having an axial forward end, and the holder having a forward surface surrounding the bore at the axial forward end of the bore. The assembly also includes a cutting tool being rotatably contained within the bore of the holder, and the cutting tool having a rearwardly facing shoulder. The assembly further includes a protective member positionable between the cutting tool and the holder. The protective member has a first member adjacent the rearwardly facing shoulder of the cutting tool and a second member adjacent the forward surface of the holder, wherein the first member has a first hardness that is greater than a second hardness of the second member. In one aspect, the second member of the protective member is in direct contact with the forward surface of the holder. In another aspect, the first member of the protective member is in direct contact with the rearwardly facing shoulder of the cutting tool.

In accordance with another aspect of the invention, a cutting tool assembly for use in impinging earth strata includes a holder containing a bore, a cutting tool rotatably contained within the bore of the holder and a protective member mediate of the cutting tool and the holder. The protective member has a first portion adjacent to the cutting tool and a second portion adjacent the holder, wherein the first portion has a first hardness that is greater than a second hardness of the second portion.

These and other aspects of the present invention will be more fully understood following a review of this specification and drawings.

### BRIEF DESCRIPTION OF THE DRAWINGS

FIG. 1 is an exploded view of a cutting tool assembly, in accordance with an aspect of the invention.

FIG. 2 is an assembled side view of the cutting tool assembly of FIG. 1, in accordance with an aspect of the invention.

FIG. 3 is a sectional view of a protective member taken along line 3-3 of FIG. 1, in accordance with an aspect of the invention.

FIG. 4 is a view similar to FIG. 3 illustrating the different hardnesses of the protective member, in accordance with an aspect of the invention.

FIG. 5 is an exploded view of an additional cutting tool assembly similar to FIG. 1, in accordance with an aspect of the invention.

### DETAILED DESCRIPTION

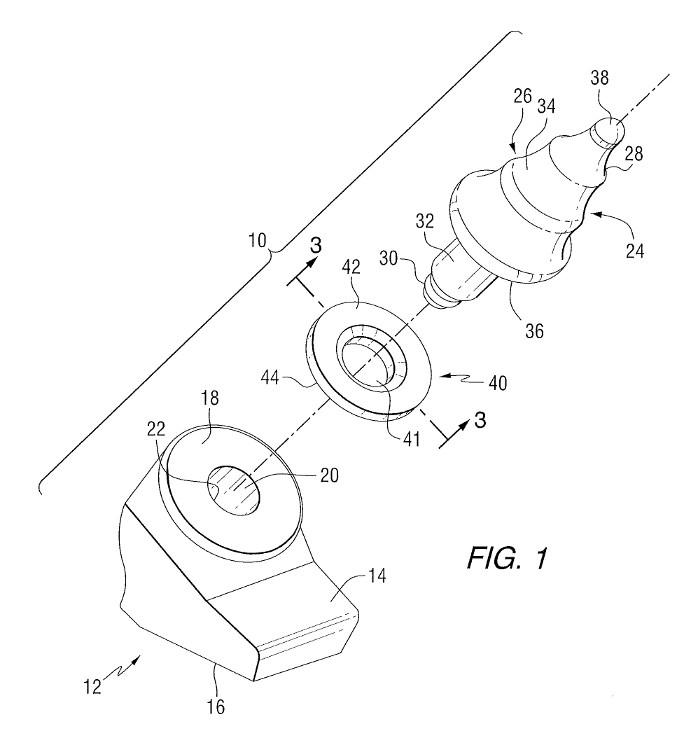

Referring to FIGS. 1-3, there is illustrated a cutting tool assembly, generally designated as 10, in accordance with an aspect of the invention. The cutting tool assembly 10 is generally useful for generating cutting debris upon impinging an earth strata. The cutting tool assembly 10 includes a holder 12 that is generally affixed to a driven member 11 such as, for example, a wheel, a chain or a drum as in the case of a road milling machine that may be used to mill the surface of an asphaltic roadway. The holder 12 has a holder body 14 that presents a base 16 and an axial forward face or surface 18 that surrounds a central bore 20. The axial forward face 18 presents a smooth surface that faces in an axial forward direction. The axial forward face 18 surrounds the bore 20 at the axial forward end 22 thereof.

The cutting tool assembly 10 also includes a rotatable cutting tool 24 that is retained within the central bore 20 of the holder 12. The rotatable cutting tool 24 is similar to the cutting tool shown and described in U.S. Pat. No. 6,478,383 B1 to Ojanen et al. Cutting tool 24 has an elongate cutting tool body 26 that has an axial forward end 28 and an axial rearward end 30. The cutting tool body 26 also presents a shank 32 adjacent the axial rearward end 30. The cutting tool body 26 further has a head portion 34 adjacent to the axial forward end 28. There is a rearwardly facing shoulder 36 at the juncture of the shank 32 and the head portion 34. Rearwardly facing shoulder 36 presents a smooth, flat surface. Cutting tool 24 also has a hard cemented carbide tip 38 affixed such as by brazing to a socket (not illustrated) at the axial forward end 28 of the cutting tool body 26.

The cutting tool assembly 10 further includes a protective member 40 having a central aperture 41. The protective member 40 is mediate of the cutting tool 24 and the holder 12. More particularly, the protective member 40 is positioned between the cutting tool 24 and the holder 12 and received on the shank 32. In one aspect, the protective member 40 is rotatable. In another aspect, the protective member 40 is generally circular although it will be appreciated that other shapes may be provided in accordance with the invention. In yet another aspect, the protective member 40 is a washer.

The protective member 40 has a first surface such as axial forward surface 42 that is adjacent the cutting tool 24. In one aspect, the axial forward surface 42 of the protective member 40 is adjacent the rearwardly facing shoulder 36 of the cutting tool 24. In another aspect, the axial forward surface 42 is in direct contact with the rearwardly facing shoulder 36 of the cutting tool 24.

The protective member 40 also includes a second surface such as axial rearward surface 44 that is adjacent the holder 12. In one aspect, the axial rearward surface 44 of the protective member 40 is adjacent the axial forward surface 18 of the holder 12. In another aspect, the axial rearward surface 44 is in direct contact with the axial forward surface 18 of the holder 12.

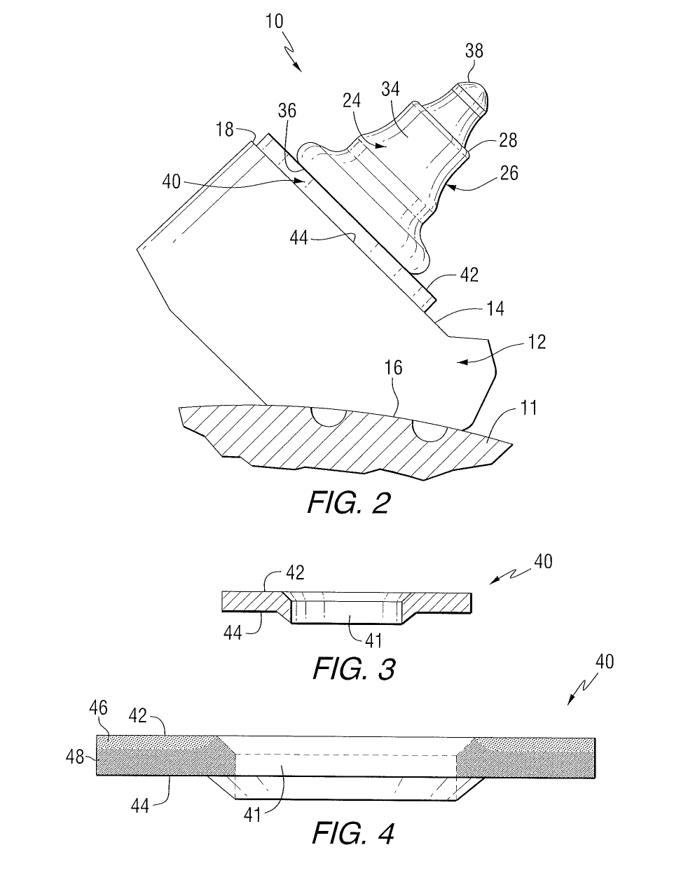

It will be appreciated that when the cutting tool assembly 10 is in the assembled position (see FIG. 2), the protective member 40 is between the cutting tool 24 and the holder 12 so as to provide wear protection between the axial forward face 18 of the holder 12 and the shoulder 36 of the rotatable cutting tool 24 as the cutting tool 24 rotates during operation. The cutting tool 24 is rotatably retained within the bore 20 of the holder 12. In this regard, the shank 32 of the cutting tool 24 is received within the bore 20. Intermediate of the axial forward face or surface 18 of the holder 12 and the rearwardly facing shoulder surface 36 of the cutting tool 24 is the protective member 40.

In accordance with an aspect of the invention, the protective member 40 is provided in such a manner so as to provide improved wear protection between the cutting tool 24 and the tool holder 12. More particularly, the protective member 40 is provided in such a manner so as to provide increased wear protection between the rearwardly facing shoulder 36 of the cutting tool 24 and the axial forward surface 18 of the tool holder 12. The improved wear protection is provided by the axial forward surface 42 of the protective member 40 having a different hardness than a hardness of the axial rearward surface 44. In one aspect, the axial forward surface 42 has a hardness value that is greater than the hardness value of the axial rearward surface 44.

In another aspect of the invention, the axial forward surface 18 of the holder 12 has a hardness value that is greater than the hardness of the axial rearward surface 44 of the protective member 40. In another aspect, the rearwardly facing shoulder 36 of the cutting tool 24 has a hardness that is less than or equal to the hardness value of the axial forward surface 42 of the protective member 40.

In use, the cutting tool 24 and protective member 40, e.g. washer, rotate and in the environment of cutting, for example, asphalt the abrasive particles get in between the rotating members. It has been determined that when one surface is softer than the other, the majority of the abrasive wear occurs on the softer member verses the harder member. Thus, by having the axial rearward surface 44 softer than the axial forward surface 18 of the holder 12 more of the wear will occur on the protective member 40 than the holder 12 and as the protective member 40 is exchanged with each cutting tool 24 change the wear is transferred to a consumable component rather than the holder 12 which is fixed to the machine. It has also been determined that the rotation of the cutting tool 24 on the axial forward surface 42 of the protective member 40 can be improved by having the hardness of surface 42 equal to or greater than the hardness of the shoulder 36. When surface 42 is harder more wear occurs on shoulder 36 and less wear occurs on the protective member 40 which enables the axial rearward surface 44 of the protective member 40 to have a higher percent of loss due to wear. As the cutting tool 24 and protective member 40 assembly is changed frequently the wearing components are renewed.

The hardness of the axial forward surface 42 may be greater than about 50 RC (RC is Rockwell C hardness). In one aspect, the hardness of the axial forward surface 42 may be in the range of about 50 RC to about 58 RC. The hardness of the axial rearward surface 44 may be less than about 45 RC. In one aspect, the hardness of the axial rearward surface 44 may be in the range of about 38 RC to about 45 RC.

The different hardnesses for surfaces 42 and 44 of the protective member 40 may be achieved by selective quenching, selective induction hardening or selective induction tempering. In one aspect, selective quenching provides for a component to be relatively unaffected by the quenching medium. This can be accomplished by insulating an area to be more slowly cooled so the quenchant contacts only those areas of the part that are to be rapidly cooled. Thus, it will be appreciated that by selectively quenching only the axial forward surface 42 of the protective member 40 and not the axial rearward surface 44 the hardness of surface 44 will be influenced by the intensity of the quench and by the alloy composition of the material, e.g. steel. Selective quenching is a single process and would use lower alloy steel and thus provide the least cost option.

In another aspect, selective induction hardening is also an option to produce the protective member 40 of the invention. For example, standard through hardened washers that are nominally 43-48 RC were reheated by induction on axial forward surface 42 and quenched to elevate the hardness to 55 RC on this surface. The processing did further soften the axial rearward surface 44 to 35 RC.

FIG. 4 is a view similar to FIG. 3 that illustrates an example of the different hardnesses that may be provided for the protective member 40, in accordance with an aspect of the invention. Specifically, a first portion, e.g. the lighter shaded area 46 adjacent the axial forward surface 42 has an increased hardness as a result of for example, selective induction hardening or other technique for providing the desired selective hardening. A second portion, e.g. the darker shaded area 48 adjacent the axial rearward surface 44 has a hardness that is lower than the lighter area 46. Thus, the axial forward surface 42 of the protective member 40 is provided to have a different hardness than a hardness of the axial rearward surface 44. In one aspect, the axial forward surface 42, therefore, has a hardness value that is greater than the hardness value of the axial rearward surface 44.

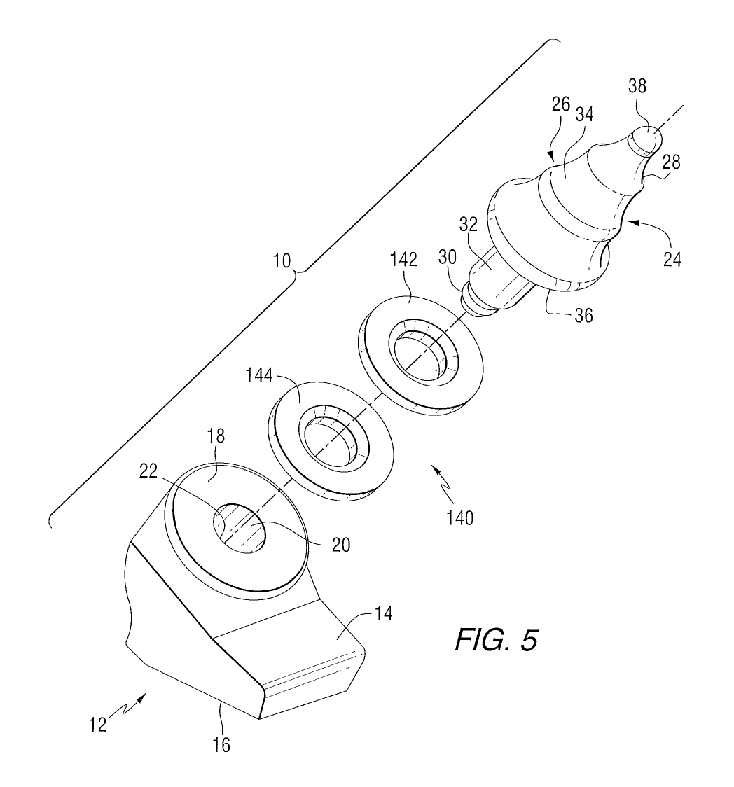

FIG. 5 is an exploded view of an additional cutting tool assembly similar to FIG. 1, in accordance with an aspect of the invention. Specifically, in FIG. 5 the protective member 140 includes a first member 142, e.g. a first washer and a second member 144, e.g. a second washer. In one aspect, the first member 142 of the protective member 140 is adjacent the rearwardly facing shoulder 36 of the cutting tool 24 and the second member 144 of the protective member 140 is adjacent the axial forward surface 18 of the holder 12. In another aspect, the first member 142 is in direct contact with the rearwardly facing shoulder 36 of the cutting tool 24 and the second member 144 is in direct contact with the axial forward surface 18 of the holder 12. The members 142 and 144 may be independent components or they may be attached to each other by, for example, mechanically staking, gluing or brazing together.

In accordance with an aspect of the invention, the protective member 140 is provided in such a manner so as to provide improved wear protection between the cutting tool 24 and the tool holder 12. More particularly, the protective member 140 is provided in such a manner so as to provide increased wear protection between the rearwardly facing shoulder 36 of the cutting tool 24 and the axial forward surface 18 of the tool holder 12. The improved wear protection is provided by the first member 142 of the protective member 140 having a different hardness than a hardness of the second member 144. In one aspect, the first member 142 has a hardness value that is greater than the hardness value of the second member 144.

In another aspect of the invention, in long service life cutting applications when the material being cut is not very abrasive for the carbide inserts, wear of the steel cutting tool body 26 and the protective member 40 becomes a major factor. The protective member 40 wear can be so drastic that the cutting tool 24 is changed early not because the cutting tip 38 or body 26 is worn away but to protect the axial forward surface face 18 of the holder 12 from wear. Aspects of the invention as set forth herein should reduce this effect.

Whereas particular aspects of this invention have been described above for purposes of illustration, it will be evident to those skilled in the art that numerous variations of the details of the present invention may be made without departing from the invention as defined in the appended claims.

What is claimed is:

1. A cutting tool assembly for use in impinging earth strata, the cutting tool assembly comprising:
a holder containing a bore;
a cutting tool being rotatably contained within the bore of the holder; and
a protective member mediate of the cutting tool and the holder, the protective member having a first surface adjacent the cutting tool and a second surface adjacent the holder, wherein the first surface has a first hardness that is different than a second hardness of the second surface.

2. The cutting tool assembly of claim 1, wherein the first hardness is greater than the second hardness.

3. The cutting tool assembly of claim 1, wherein the first hardness is greater than about 50 RC.

4. The cutting tool assembly of claim 1, wherein the second hardness is less than about 45 RC.

5. The cutting tool assembly of claim 1, wherein the bore of the holder has an axial forward end and the holder has a forward surface surrounding the bore at the axial forward end of the bore, and wherein the second surface of the protective member is adjacent the forward surface of the holder.

6. The cutting tool assembly of claim 5, wherein the second surface of the protective member is in contact with the forward surface of the holder.

7. The cutting tool assembly of claim 5, wherein the forward surface of the holder has a hardness that is greater than the second hardness of the second surface of the protective member.

8. The cutting tool assembly of claim 1, wherein the cutting tool has a rearwardly facing shoulder and wherein the first surface of the protective member is adjacent the rearwardly facing shoulder of the cutting tool.

9. The cutting tool assembly of claim 8, wherein the first surface of the protective member is in contact with the rearwardly facing shoulder of the cutting tool.

10. The cutting tool assembly of claim 8, wherein the rearwardly facing shoulder of the cutting tool has a hardness that is less than or equal to the first hardness of the first surface of the protective member.

11. The cutting tool assembly of claim 1, wherein the protective member is rotatable.

12. The cutting tool assembly of claim 1, wherein the protective member is generally circular.

13. The cutting tool assembly of claim 1, wherein the protective member is a washer.

14. A cutting tool assembly for use in impinging earth strata, the cutting tool assembly comprising:
a holder containing a bore having an axial forward end, and the holder having a forward surface surrounding the bore at the axial forward end of the bore;
a cutting tool being rotatably contained within the bore of the holder, and the cutting tool having a rearwardly facing shoulder; and
a protective member positionable between the cutting tool and the holder, the protective member having a first surface adjacent the rearwardly facing shoulder of the cutting tool and a second surface adjacent the forward surface of the holder, wherein the first surface has a first hardness that is greater than a second hardness of the second surface.

15. The cutting tool assembly of claim 14, wherein the first hardness is greater than about 50 RC.

16. The cutting tool assembly of claim 14, wherein the second hardness is less than about 45 RC.

17. The cutting tool assembly of claim 14, wherein the second surface of the protective member is in contact with the forward surface of the holder.

18. The cutting tool assembly of claim 14, wherein the forward surface of the holder has a hardness that is greater than the second hardness of the second surface of the protective member.

19. The cutting tool assembly of claim 14, wherein the first surface of the protective member is in contact with the rearwardly facing shoulder of the cutting tool.

20. The cutting tool assembly of claim 14, wherein the rearwardly facing shoulder of the cutting tool has a hardness that is less than or equal to the first hardness of the first surface of the protective member.

21. The cutting tool assembly of claim 14, wherein the protective member is rotatable.

22. The cutting tool assembly of claim 14, wherein the protective member is generally circular.

23. The cutting tool assembly of claim 14, wherein the protective member is a washer.

24. A protective member positioned between a holder containing a bore and a cutting tool being rotatably contained within the bore of the holder to provide a cutting tool assembly for use in impinging earth strata, the protective member comprising:
a first surface adjacent the cutting tool and a second surface adjacent the holder, wherein the first surface has a first hardness that is greater than a second hardness of the second surface.

25. The protective member of claim 24, wherein the first hardness is greater than about 50 RC.

26. The protective member of claim 24, wherein the second hardness is less than about 45 RC.

27. The protective member of claim 24, wherein the protective member is rotatable.

28. The protective member of claim 24, wherein the protective member is generally circular.

29. The protective member of claim 24, wherein the protective member is a washer like element.

30. A cutting tool assembly for use in impinging earth strata, the cutting tool assembly comprising:
a holder containing a bore having an axial forward end, and the holder having a forward surface surrounding the bore at the axial forward end of the bore;
a cutting tool being rotatably contained within the bore of the holder, and the cutting tool having a rearwardly facing shoulder; and
a protective member positionable between the cutting tool and the holder, the protective member having a first member adjacent the rearwardly facing shoulder of the cutting tool and a second member adjacent the forward surface of the holder, wherein the first member has a first hardness that is greater than a second hardness of the second member.

31. The cutting tool assembly of claim 30, wherein the first member is a washer.

32. The cutting tool assembly of claim 30, wherein the second member is a washer.

33. The cutting tool assembly of claim 30, wherein the first hardness is greater than about 50 RC.

34. The cutting tool assembly of claim 30, wherein the second hardness is less than about 45 RC.

35. The cutting tool assembly of claim 30, wherein the second member of the protective member is in contact with the forward surface of the holder.

36. The cutting tool assembly of claim 30, wherein the forward surface of the holder has a hardness that is greater than the second hardness of the second member of the protective member.

37. The cutting tool assembly of claim 30, wherein the first member of the protective member is in contact with the rearwardly facing shoulder of the cutting tool.

38. The cutting tool assembly of claim 30, wherein the rearwardly facing shoulder of the cutting tool has a hardness that is less than or equal to the first hardness of the first member of the protective member.

39. The cutting tool assembly of claim 30, wherein the first member is adjoined to the second member.

40. A cutting tool assembly for use in impinging earth strata, the cutting tool assembly comprising:
a holder containing a bore;
a cutting tool being rotatably contained within the bore of the holder; and
a protective member mediate of the cutting tool and the holder, the protective member having a first portion adjacent the cutting tool and a second portion adjacent the holder, wherein the first portion has a first hardness that is greater than a second hardness of the second portion.

41. The cutting tool assembly of claim 40, wherein the bore of the holder has an axial forward end and the holder has a forward surface surrounding the bore at the axial forward end of the bore, and wherein the second portion of the protective member includes a surface that is adjacent the forward surface of the holder.

42. The cutting tool assembly of claim 41, wherein the surface of the second portion of the protective member is in contact with the forward surface of the holder.

43. The cutting tool assembly of claim 40, wherein the cutting tool has a rearwardly facing shoulder and wherein the first portion of the protective member includes a surface that is adjacent the rearwardly facing shoulder of the cutting tool.

44. The cutting tool assembly of claim 43, wherein the surface of the first portion of the protective member is in contact with the rearwardly facing shoulder of the cutting tool.
